(19) United States
(12) Patent Application Publication
(10) Pub. No.: US 2009/0074310 A1
(43) Pub. Date: Mar. 19, 2009

(54) IMAGE DATA COMPRESSION METHOD

(75) Inventors: SHAOU-GANG MIAOU, TAOYUAN COUNTY (TW); FU-SHENG KE, TAOYUAN COUNTY (TW); CHIH-CHING CHANG, TAOYUAN COUNTY (TW); CHUEN-TAI YEH, HSINCHU CITY (TW); TAH-YEONG LIN, LONG-TAN (TW); SHU-CHING CHEN, TAOYUAN COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: CHUNG SHAN INSTITUTE OF SCIENCE AND TECHNOLOGY, ARMAMENTS BUREAU, M.N.D., TAOYUAN COUNTY (TW)

(21) Appl. No.: 11/857,706

(22) Filed: Sep. 19, 2007

(51) Int. Cl. G06K 9/36

(52) U.S. Cl. 382/236; 382/244

(57) ABSTRACT

An image data compression method is disclosed. Firstly, check a variance between a first image data and a second image data for comparing the variance with a threshold value. When the variance is smaller than a threshold value, compare the first image data with the second image data to generate a motion vector and compress the motion vector. Then calculate the first image data and the second image data according to the motion vector so as to get an offset value of the motion vector. Next, encode the offset value of the motion vector, compress the offset value of the motion vector, and encode as well as compress the first image data. Thus the compression ratio is improved and image distortion is avoided.

### BACKGROUND OF THE INVENTION

The present invention relates to a compression method, especially to a compression method related with image data.

Along with fast development of computer technology and multimedia technology, a lot of digital information such as image, audio, video and text data is transmitted through the Internet. And these data are saved in computer storage devices in the form of Digital Multimedia for more stable, effective and long-term data storage. Owing to huge amount of the data, such multimedia data needs to be compressed for shorting of transmission time.

Conventionally, compression technology has two categories—Lossy Compression and Lossless Compression. Although compression effect of lossless compression is far inferior to that of the lossy compression, the lossless compression still plays an important role, meeting requirements of a lot of applications such as medical imaging, satellite remote sensing images, images of antiquities in digital museum, and biomedical image processing and analysis. The above applications have following common features: high requirements of image quality, high cost of image acquisition, complete and precise image compression and storage, and image analysis being used as judging criteria.

Furthermore, in medical systems nowadays, conventional medical equipment is replaced by digital medical devices such as capsule endoscopy that sends out the shot images from human bodies and the images are received by receivers outside. Because the receiver needs to work as long as 6-8 hours on patients, it must be compact, light weight and energy-saving. Thus a lot of challenges raised while designing the receivers. For example, as to digital cameras, decades of photos take huge memory space. In capsule endoscopy, more than fifty thousand photos may be shot inside the patient and the receiver needs to get them all available to the medical staff for providing diagnosis. Moreover, the image must be displayed in details so that medical staff can provide diagnosis and treatment according to the images accurately. Once lossy compression is applied, although the compression ratio is high, the image may distort while decompressing the images. Thus doctors may have errors in diagnosis due to distortion of the images.

There is a need to provide a novel image data compression method that not only overcomes distortion of the image while decompressing the image but also improves compression ratio.

### SUMMARY OF THE INVENTION

Therefore it is a primary object of the present invention to provide an image data compression method that compresses image data with higher compression ratio by exploiting the characteristic of original image arrangements.

It is a further object of the present invention to provide an image data compression method that compresses data by lossless compression method for avoiding image distortion.

In order to achieve above objects, the image data compression method according to the present invention is composed of the following steps: check a variance between a first image data and a second image data and compare the variance with a threshold value. When the variance is smaller than a threshold value, compare the first image data and the second image data to estimate and generate a motion vector and compress the motion vector. Then calculate the first image data and the second image data according to the motion vector so as to get an offset value of the motion vector. Next, encode the offset value of the motion vector, compress the offset value of the motion vector, and encode as well as compress the first image data.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flow chart of an embodiment according to the present invention;

FIG. 2A is a schematic drawing showing searching of motion vector;

FIG. 2B is a schematic drawing showing the finding of the motion vector; and

FIG. 3 is a data list of an embodiment according to the present invention.

### DETAILED DESCRIPTION OF THE PREFERRED EMBODIMENT

An image data compression method according to the present invention compresses image data with higher compression ratio by exploiting the characteristic of original image arrangements. And an encoding method JPEG-LS is used so as to prevent image distortion. Moreover, the present invention is applied to capsule endoscopy so that medical staff can make a diagnosis according to images shot by the technique.

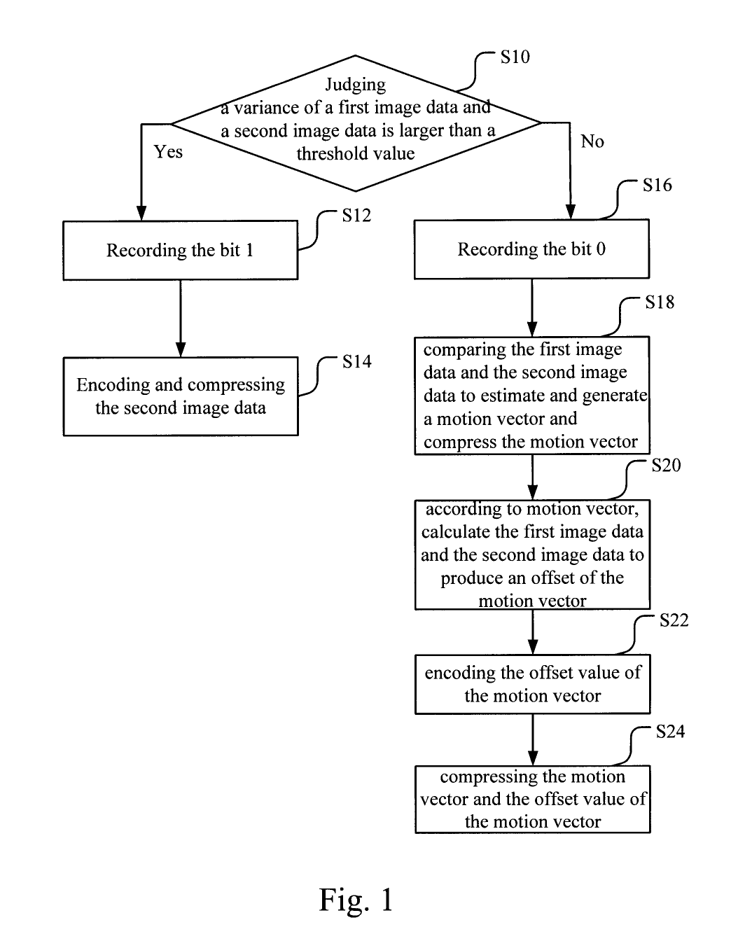

Refer to FIG. 1, at first, run step S10, check a variance between a first image data and a second image and judge that the variance is larger than a threshold value while the image data is in sequential pattern. That means the images are continuous. Thus the first image data is image data previous to the second image data. When the variance between the first image data and the second image data is larger than the threshold value, run the step S12, record the bit as “1” so as to identify the data when being decompressed again. Next take the step S14, the second image data is encoded and compressed by JPEG-LS (Joint Photographic Experts Group Lossless). It is noted that in order to avoid reduced compression performance of the motion estimation algorithm caused by large image variance between the first image data and the second image data, variance between the first image data and the second image data needs to be checked so as to determine whether the motion estimation algorithm is used to compress the data. Moreover, variance is got by subtracting one image data from the other image data so as to generate a third image data, then the third image data is an image data of pixel value difference. Then calculate the third image data to get average value of the third image data and further calculate variance according to the mean (average value).

When the variance is over the threshold value, this represents large differences between the first image data and the second image data. For example, when an image showing forest changes to an image showing canyon, the variance between the two images is quite large. While a man is riding a bike, there is only a bit difference between the two adjacent images. The variance is smaller than the threshold value and this means the difference between the first image data and the second image data is quite small. The threshold value is preferred to be set in 180. The variance is calculated by the following equations:

$$E [ D ] = \frac{1}{m} {\sum }_{x = 1}^{m} D ( x ) = \overline{D}$$

$${E}^{2} [ D ] = \frac{1}{m} {\sum }_{x = 1}^{m} {( D ( x ) )}^{2}$$

$$VAR [ D ] = {E}^{2} [ D - \overline{D} ] = {E}^{2} [ D ] - {\overline{D}}^{2}$$

wherein D(x) is the third image data, E[D] is average value of the third image data and VAR[D] is variance.

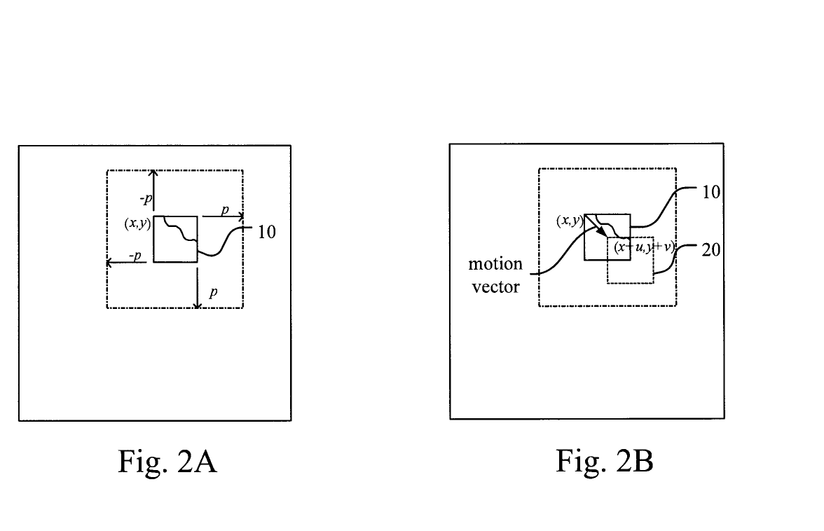

After checking whether the variance between the first image data and the second image data is no more than the threshold value or not, once the variance is smaller or equal to the threshold value, run step S16-record the bit as “0” for convenience of data identification while being decompressed. Next refer to step SI 8, compare the first image data and the second image data to estimate and generate a motion vector and compress the motion vector. Refer to FIG. 2A & FIG. 2B, schematic drawings show how to find the motion vector. While processing the related two adjacent images-the first image data and the second image data, a plurality of matrix data is generated according to the second images data and then move in all directions for searching relative positions of these matrix data in the first image data so as to get a plurality motion vector.

Refer to step S20, according to motion vector, calculate the first image data and the second image data to produce an offset of the motion vector. According to the plurality of motion vector, the first image data is used to reconstruct the second image data so as to generate a fourth image data. Then the fourth image data and the second image data are subtracted from each other so as to get an offset value of motion vector. Next run step S22 and step S24, encode the offset value of the motion vector, compress the motion vector as well as the offset value of the motion vector, and encode as well as compress the first image data.

It is noted that in the step of compressing the motion vector, bit size of the motion vector being encoded is determined by distance p while searching relative positions in all directions. p=2ⁿ⁻¹−1 When distance p=7, the bit size is 4, n=4. Furthermore, the image data in the embodiment is two dimensional so that the motion vector includes two components being compressed respectively. That means the vector includes two numbers-X component and Y component, being calculated respectively. The compression methods of components of the motion vector are as followings:

firstly, record sign of the component of the motion vector by bit “1” or “0”.

Then compress the absolute value of each component of the motion vector by JPEG-LS. The second method is adding each component of the plurality of motion vector with the distance p and JPEG-LS compression of n bit is performed. The third compression method is by using one more bit to represent whether the component of the motion vector is zero or not. When the component is zero, the bit “0” is transmitted. On the other hand, when the component of the motion vector is not zero, transmit the bit “1”. And encode the component of the motion vector. The above methods are some embodiments of compression of the motion vector.

In addition, after the step of generating the offset value of the motion vector, the sign of the offset value of the motion vector needs to be recorded separately and the absolute value of the offset value of the motion vector is calculated. Or add the calculated offset value of the motion vector with value of 255 so as to make the offset value of the motion vector become a positive value.

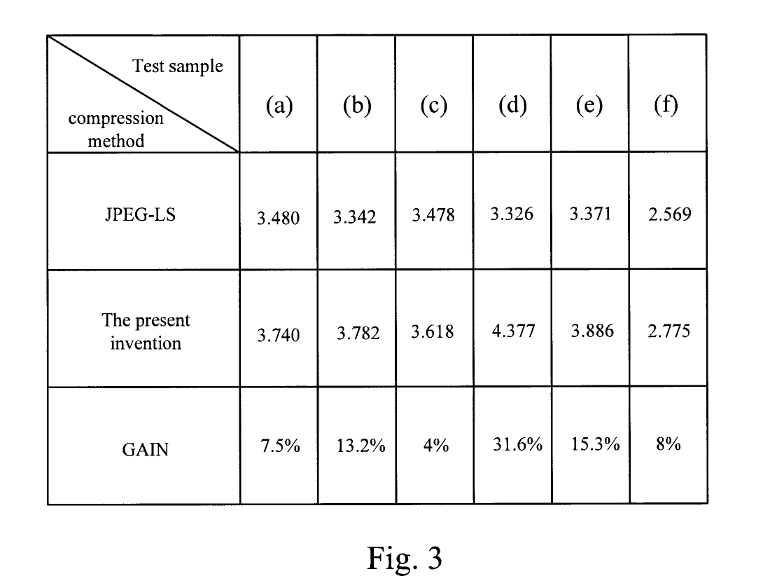

Refer to FIG. 3, a comparison data list of an embodiment according to the present invention is disclosed. As shown in figure, test samples consists of (a), (b), (c), (d), (e) and (f), each having one hundred photos shot by capsule endoscopy. Compare with the compression ratio of conventional JPEG-LS, the present invention has better compression ratio.

In summary, an image data compression method according to the present invention include the steps of: firstly compare a variance between a first image data and a second image data with a threshold value. When the variance is smaller than a threshold value, compare the first image data and the second image data to estimate and generate a motion vector and compress the motion vector. Then according to the motion vector, calculate the first image data and the second image data so as to get an offset value of the motion vector. Next, encode the offset value of the motion vector, compress the offset value of the motion vector, and encode as well as compress the first image data.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An image data compression method comprising the steps of:
checking a variance between a first image data and a second image data and finding that the variance is smaller than a threshold value;
comparing the first image data with the second image data to generate a motion vector and compressing the motion vector;
calculating the first image data and the second image data according to the motion vector so as to produce an offset value of the motion vector;
encoding the offset value of the motion vector; and
compressing the offset value of the motion vector and encoding as well as compressing the first image data.

2. The method as claimed in claim 1, wherein the first image data is an image data previous to the second image data.

3. The method as claimed in claim 1, wherein the step of checking a variance between a first image data and a second image data and finding that the variance is smaller than a threshold value further comprising the steps of:
calculating pixel value difference between the first mage data and the second image data to produce a third image data;
calculating an average value of image according to the third image data; and
calculating the variance according to the average value of image.

4. The method as claimed in claim 1, wherein the threshold value is 180.

5. The method as claimed in claim 1, wherein the step of comparing the first image data with the second image data to generate a motion vector and compressing the motion vector further comprising the steps of:
cutting the second image data to generate a plurality of matrix data; and
moving the matrix data in the first image data for searching relative positions of the matrix data so as to produce the motion vector.

6. The method as claimed in claim 5, wherein the step of moving the matrix data in the first image data for searching relative positions of the matrix data so as to produce the motion vector further comprising:
moving the matrix data in all directions so as to find out positions corresponding to the matrix data.

7. The method as claimed in claim 1, wherein the step of calculating the first image data and the second image data according to the motion vector so as to produce an offset value of the motion vector further comprising the steps of:
moving the first image data according to the motion vector to produce a fourth image data; and calculating pixel value difference between the second mage data and the fourth image data to produce an offset value of the motion vector.

8. The method as claimed in claim 1, wherein the step of checking a variance between a first image data and a second image data and finding that the variance is smaller than a threshold value further comprising a step of;
saving a bit.

9. The method as claimed in claim 1, wherein before the step of comparing the first image data with the second image data to generate a motion vector and compressing the motion vector, the method further comprising a step of:
saving a bit.

10. The method as claimed in claim 1, wherein the step of compressing the motion vector further comprising steps of:
encoding the motion vector; and
compressing absolute value of each component of the motion vector.

11. The method as claimed in claim 1, wherein the step of compressing the motion vector further comprising steps of:
adding one more bit for encoding the motion vector and increasing value of the motion vector; and
compressing the motion vector.

12. The method as claimed in claim 1, wherein the step of compressing the motion vector further comprising steps of:
adding one more bit for checking component of the motion vector, once finding the component of the motion vector is zero, bit “0” is output; and
outputting bit “1” and encoding the motion vector.

13. The method as claimed in claim 1, wherein after the step of calculating the first image data and the second image data according to the motion vector so as to produce an offset value of the motion vector, the method further comprising a step of:
calculating absolute value of the offset value of the motion vector.

14. The method as claimed in claim 1, wherein after the step of calculating the first image data and the second image data according to the motion vector so as to produce an offset value of the motion vector, the method further comprising a step of:
adding a value to the offset value of the motion vector.

15. The method as claimed in claim 14, wherein the value is 255.

16. The method as claimed in claim 1, wherein the method is applied to a capsule endoscopy system.

17. The method as claimed in claim 1, wherein in the step of encoding the second image data, the encoding is performed by Joint Photographic Experts Group Lossless (JPEG-LS).

18. The method as claimed in claim 1, wherein in the step of encoding the offset value of the motion vector, the encoding is performed by Joint Photographic Experts Group Lossless (JPEG-LS).
